(19) United States
(12) Patent Application Publication
(10) Pub. No.: US 2011/0131203 A1
(43) Pub. Date: Jun. 2, 2011

(54) Determining Website Relevancy at the Time of Asset Usage using Location Based Services

(75) Inventors: William K. Bodin, Austin, TX (US); David Jaramillo, Boca Raton, FL (US); Derral C. Thorson, Austin, TX (US)

(73) Assignee: International Business Machines Corporation, Armonk, NY (US)

(21) Appl. No.: 12/629,758

(22) Filed: Dec. 2, 2009

(51) Int. Cl. G06F 17/30; G01S 19/24

(52) U.S. Cl. 707/724; 707/725; 707/E17.109

(57) ABSTRACT

An embodiment of the invention includes a method for searching for mobile assets in accordance with location. A monitoring module monitors usage of assets in a plurality of mobile devices to identify assets used in different locations. For each usage of an asset, the monitoring module identifies the location of the mobile device utilizing the asset via a global positioning system. A search query for a requested asset is received from a requesting mobile device. The location of the requesting mobile device is identified. Assets that are used in the location of the requesting mobile device are identified based on the monitoring of the usage of assets. Results of the search query are weighed by assigning higher rankings to the assets used in the location of the requesting mobile device. The results of the search query are sent to the requesting mobile device and/or an interface.

### FIELD OF THE INVENTION

The present invention is in the field of methods, systems, and computer program products for determining website relevancy at the time of asset usage using location based services (LBS).

### SUMMARY OF THE INVENTION

An embodiment of the invention includes a method for creating a social networking system, in which users can search for mobile applications and web applications in accordance with their location. More specifically, a monitoring module monitors usage of assets in a plurality of mobile devices. The monitoring module identifies assets used in different locations, assets used at different time periods, and/or assets used by different device types.

For each usage of an asset (e.g., downloading and/or launching of the asset), the monitoring module identifies the location of the mobile device utilizing the asset via a global positioning system. The monitoring module also identifies, for each usage of an asset, the device type of the mobile device utilizing the asset and/or time that the asset was utilized.

A search query for a requested asset is received from a requesting mobile device. The location and/or device type of the requesting mobile device is identified. The time that the search query was received is also identified. Assets that are used in the location (e.g., geographic region) of the requesting mobile device are identified based on the monitoring of the usage of assets. Assets that are used by the device type of the requesting mobile device and/or assets used during a time period that the search query was received from the requesting mobile device are also identified based on the monitoring of the usage of assets.

Results of the search query are weighed by assigning higher rankings to the assets used in the location of the requesting mobile device, assets used by the device type of the requesting mobile device, and/or assets used during the time period that the search query was received from the requesting mobile device. The results of the search query are sent to the requesting mobile device and/or an interface. Only assets that match the location of the requesting mobile device and/or assets that are compatible with the device type of the requesting mobile device are sent in the search results.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 is a flow diagram illustrating a method for searching for mobile assets according to an embodiment of the invention;

FIG. 2 illustrates a system for searching for mobile assets according to an embodiment of the invention; and

FIG. 3 illustrates a computer program product according to an embodiment of the invention.

### DETAILED DESCRIPTION

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

An embodiment of the invention includes a method for reporting when and where assets (e.g., mobile applications and/or web applications) are launched and used. Results from these reports are accumulated or posted immediately, dependent upon user or system preferences, to a server or cloud based application. Thus, the method delivers relevant information to mobile devices (e.g., smart phones, netbooks, navigation systems, and other telematic devices) when users need it, and with a direct connection to where users are and what users are doing or need to do.

At least one embodiment of the invention creates a social networking system, in which users can search for assets, such as, for example, mobile applications and web applications. The locale relevancy for the assets is determined and consistently updated according to the usage of the assets. As described below, these metrics are posted in the social networking system, such that users can search for assets based on their current location. Accordingly, an embodiment of the invention provides locally relevant information to mobile devices using location based services (LBS), including global positioning systems (GPS) technologies, to gather, post, and organize assets in dependence with the locale or geographic region in which the assets are associated with based on, for example, use of the assets.

An embodiment of the invention includes a client mobile application that organizes assets, including both web applications and native applications, such as platform-specific applications or platform-neutral applications. The client mobile application interacts with a backend server repository which is comprised of at least one database, a server (e.g., a hypertext transfer protocol server), and associated web services. The client mobile application is used to organize potentially hundreds of assets, many of which have a particular local, state, regional, or country association. The mobile client application uses LBS or GPS services to associate a given location, time, and date with a mobile asset. These associations allow users of the backend system to search more specifically for applications that will address their needs.

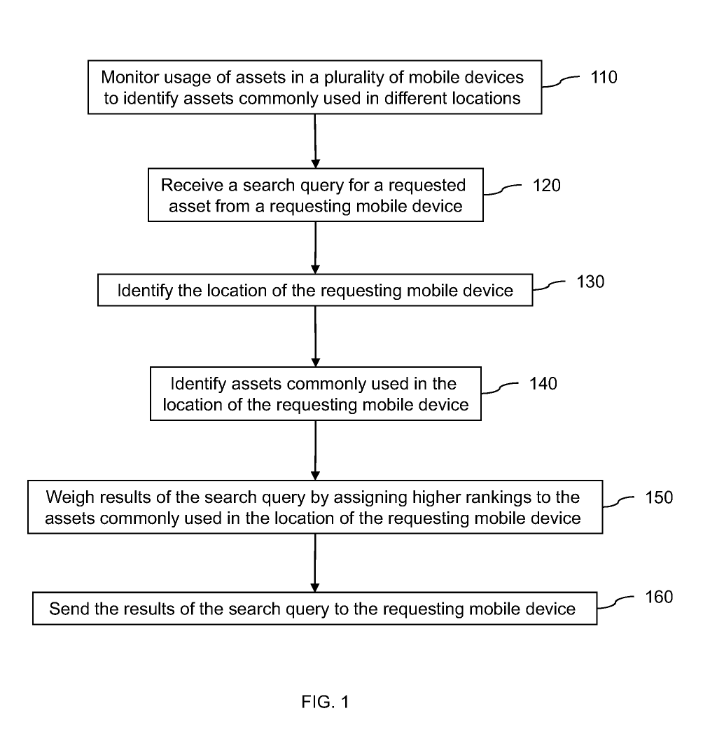

FIG. 1 is a flow diagram illustrating a method for searching for mobile assets (e.g., mobile telephone applications and/or web applications) based on location according to an embodiment of the invention. A monitoring module (or means for monitoring usage of assets) monitors usage of assets in a plurality of mobile devices to identify assets commonly used in different locations (110). In one example, the monitoring module monitors all of the mobile devices being serviced by service provider X. In another example, the monitoring module monitors all of the mobile devices owned by company Y. The usage of the assets includes downloading of assets (e.g., downloading a codec for an MP3 player) and/or launching of assets (e.g., invoking a weather report web application).

For each usage of an asset, the monitoring module identifies the location of the mobile device utilizing the asset using GPS/LBS. In another embodiment, the monitoring module identifies the location of the mobile device utilizing the asset by accessing usage records maintained by asset providers (e.g., iTunes™) and/or mobile service providers (e.g., Verizon Wireless™). For example, the monitoring module obtains a record of the assets used by a mobile device user, and determines his or her location via the billing address and/or area code of the mobile device.

The location metric can be defined by, for example, area code, street address, city, state, zip code, longitude and latitude coordinates, geographic region, and/or other location parameter defined by a user and/or system administrator. For example, the monitoring module identifies that a web application for the Washington D.C. metro transit system has been utilized 500 times in Silver Spring, Md., 200 times in Columbia, Md., 20 times in Cumberland, Md., and 5 times in Philadelphia, Pa. In another example, the monitoring module identifies that a mobile application for downloading ringtones has been utilized 100 times in the 33299 zip code, 70 times in the 33694 zip code, and 30 times in the 34120 zip code.

In at least one embodiment of the invention, the monitoring module identifies, for each usage of an asset, the device type of the mobile device utilizing the asset. The device type metric can be defined by, for example, mobile devices from a particular manufacturer (e.g., Nokia™), a specific model number, mobile devices being serviced by a particular service provider (e.g., Sprint™), mobile devices having certain capabilities (e.g., web browser, e-mail, full QWERTY keyboard, and/or Bluetooth technology), and/or other device types defined by a user and/or system administrator. Thus, for example, the monitoring module identifies that a web application for a turn-by-turn navigation system has been utilized 250 times in locations less than 30 miles from the Denver, Colo. metropolitan area, and 45 times in locations 30-100 miles from the Denver, Colo. metropolitan area.

In at least one embodiment, the monitoring module identifies, for each usage of an asset, the time period that the asset is utilized by the mobile device. The time metric can be defined by, for example, specific time ranges (e.g., 12:00 pm to 12:30 pm), morning, afternoon, evening, days of the week, weekends vs. weekdays, month of the year, date ranges (e.g., a holiday season), and/or other time period defined by a user and/or system administrator. Thus, for example, the monitoring module identifies that a web application for viewing real-time scores for sporting events is used 925 times on Sundays and 310 times on Mondays.

In at least one embodiment, the monitoring module identifies, for each usage of an asset, the location of the mobile device utilizing the mobile asset, the device type of the mobile device utilizing the asset, and/or the time period that the asset is utilized by the mobile device. In one example, the monitoring module identifies that a mobile application for playing MP3 music files is frequently used on iPhones™ between 6:00 pm to 8:00 pm. In another example, the monitoring module identifies that a web application for viewing Chicago traffic reports is frequently used on Motorola™ phones in the state of Illinois between 7:00 am to 10:00 am.

In at least one embodiment of the invention, location, device type, and/or time metrics are collected and stored in a database, which is utilized to generate usage reports. In another embodiment, an asset repository is created, which includes assets that are identified by the monitoring module as satisfying a predetermined level of usage as defined by a user and/or system administrator. For example, a user programs the system to gather and store mobile assets that have been used more than 500 times in the state of Michigan. In another example, the system administrator programs the system to gather and store mobile assets that have been used more than 100 times by Samsung Gravity™ mobile telephones. In at least one embodiment, the asset repository is updated in a dynamic or incremental basis (as defined by the user and/or system administrator, e.g., update on a daily basis at 12:00 a.m.) by adding or removing mobile assets based on the usage observed by the monitoring module.

A communication module (or means for receiving a search query) receives a search query for a requested asset from a requesting mobile device (120). For example, a user who wishes to download a web application for weather reports enters the search term “weather” into his mobile device. A processor (or means for identifying a location of the requesting mobile device) operatively connected to the monitoring module and the communication module identifies the location of the requesting mobile device, for example, using GPS (130). In at least one embodiment, the processor identifies the device type of the requesting mobile device and/or the time period that the search query was received from the requesting mobile device.

The processor (or means for identifying assets used in the location of the requesting mobile device) also identifies assets commonly used in the location of the requesting mobile device based on data collected by the monitoring module (140). For example, the processor identifies that a web application for reporting airline travel delays is commonly used in Atlanta, Ga. In another example, the processor identifies that a web application for stock market reports is commonly used in New York, N.Y.

In at least one embodiment of the invention, the processor uses the data collected by the monitoring module to identify assets commonly used with the device type of the requesting mobile device and/or assets commonly used during the time period that the search query was received from the requesting mobile device. For example, the processor identifies that a mobile application for receiving and sending e-mail messages is commonly used in BlackBerry™ mobile devices. In another example, the processor identifies that a web application for nautical weather reports is commonly used on Saturdays.

A ranking module (or means for weighing results of the search query) in the processor weighs the results of the search query by assigning higher rankings to the assets commonly used in the location of the requesting mobile device (150). In at least one embodiment, assets that are “commonly used” are defined by the system administrator and/or user. For example, the system administrator defines “commonly used” as a mobile asset downloaded more than 50 times within a 5 mile radius of the user's GPS location. In another example, the user defines “commonly used” as an asset downloaded or launched more than 100 times in the user's zipcode and/or more than 500 times in the user's state.

In at least one embodiment, once the mobile assets that are commonly used in the location of the requesting mobile device are identified, the mobile assets are ranked according to distance between the requesting mobile device and where the mobile assets were used. For example, mobile assets that were used in the user's city (e.g., Seattle) are ranked higher than mobile assets that were used in the user's state (e.g., Washington), which are ranked higher than mobile assets that were used in the user's region (e.g., Northwest United States). In another example, mobile assets that were used less than 10 miles from the requesting mobile device are ranked higher than mobile assets that were used 10-25 miles from the requesting mobile device, which are ranked higher than mobile assets that were used 26-50 miles from the requesting mobile device. In yet another example, if the user defines “commonly used” as downloaded or launched one or more times, then the mobile assets are ranked according to distance from the requesting mobile device (either latitude/longitudinal distance or distance via automobile roadways).

In at least one embodiment of the invention, the ranking module weighs the results of the search query by assigning higher rankings to the mobile assets commonly used during the time period that the search query was received from the requesting mobile device. As discussed above, “commonly used” (e.g., more than 100 times or other predetermined number of times) and the time period (e.g., day of week) are defined by the system administrator and/or user. Thus, for example, if the search query was received at 2:15 p.m., mobile assets used between 2:00 p.m. - 3:00 p.m. are ranked higher than mobile assets used between 3:00 p.m.-4:00 p.m., which are ranked higher than mobile assets used between 12:00 p.m.-1:00 p.m.

In at least one embodiment, if the user and/or system administrator defines more than one time period (e.g., two time periods: Time Period 1=1-hour increments starting at the beginning of the hour; and, Time Period 2=day of the week), then the time periods are given equal weight in the rankings (i.e., 50% and 50%), unless otherwise modified by the user and/or system administrator (e.g., Time Period 1 weighed 70%; Time Period 2 weighed 30%). Thus, for example, given the above Time Period 1 and Time Period 2 with equal weight, if the search query was received at 10:35 a.m. on a Tuesday, mobile assets used between 12:00 p.m.-1:00 p.m. on Tuesdays are ranked higher than mobile assets used between 3:00 p.m.-4:00 p.m. on Sundays, which are ranked higher than mobile assets used between 1:00 a.m.-2:00 a.m. on Fridays. However, in another embodiment, the user and/or system administrator assigns a higher weight to the hourly time periods or the days of the week.

In at least one embodiment of the invention, the ranking module weighs the results of the search query by assigning higher rankings to the assets commonly used with the device type of the requesting mobile device. As discussed above, “commonly used” (e.g., more than 500 times) and the device type (e.g., manufacturer, model number, and/or device capabilities) are defined by the system administrator and/or user.

In at least one embodiment, if the user and/or system administrator defines more than one device type (e.g., two device types: Device Type 1=manufacturer; and, Device Type 2=Bluetooth capabilities), then the device types are given equal weight in the rankings (i.e., 50% and 50%), unless otherwise modified by the user and/or system administrator (e.g., Device Type 1 weighed 80%; Device Type 2 weighed 20%). Thus, for example, given the above Device Type 1, Device Type 2, and 80%/20% rating scale, if the requesting mobile device was manufactured by company XYZ with Bluetooth capabilities, mobile assets used by mobile devices manufactured by company XYZ without Bluetooth capabilities are ranked higher than mobile assets used by mobile devices manufactured by company ABC with Bluetooth capabilities. However, in another embodiment, the user and/or system administrator assigns a higher weight to the device capabilities metric.

In at least one embodiment, the ranking module weighs the results of the search query based on the location, time, and/or device type metrics, wherein the respective weights of the metrics are equal (e.g., 33% location, 33% time, and 33% device type). In another embodiment, however, the respective weights are adjustable by a user or administrator of the system (e.g., the location metric is more important than the time metric; the device type metric is more important than the location metric). In yet another embodiment, the ranking module produces multiple search results, e.g., first search results weighed by the location metric, second search results weighed by the time metric, third search results weighed by the device type metric fourth search results weighed by the location metric and time metrics, fifth search results weighed by the location metric and device type metrics, and/or sixth search results weighed by the time and device type metrics. In at least one embodiment, the identification and weighing is performed transparent to the user.

The communication module (or means for sending the results of the search query) sends the results of the search query to the requesting mobile device (160). In at least one embodiment, the results of the search query are also sent to an interface (e.g., a website). In another embodiment, results of multiple search queries are compiled and displayed on the interface. For example, a user can go to a website and view search results for the query “Adobe Acrobat™” sent from iPhones™ in Houston, Texas on weekdays. In at least one embodiment, the communication module only sends search results that match the user's metrics, e.g., only assets that have been used in the user's location with the user's device type.

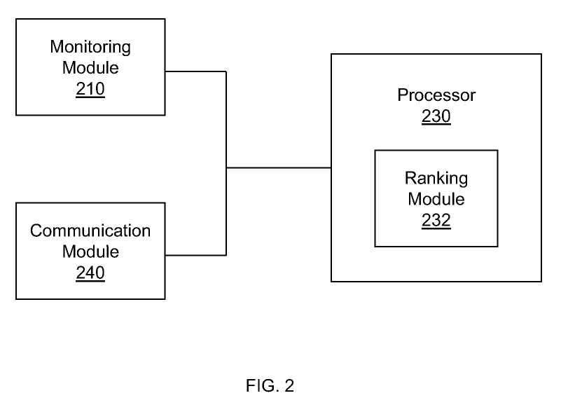

FIG. 2 illustrates a system for searching for mobile assets according to an embodiment of the invention. The system includes a monitoring module 210 for monitoring usage of assets in a plurality of mobile devices. In at least one embodiment, the monitoring module 210 includes applets on the mobile devices. The monitoring module 210 identifies assets used in different locations, assets used at different time periods, and/or assets used by different device types. In at least one embodiment, for each usage of an asset (e.g., downloading and/or launching of an asset), the monitoring module 210 identifies the location of the mobile device utilizing the asset via a location based service, e.g., a global positioning system.

The system further includes a communication module 220 for receiving a search query for a requested asset from a requesting mobile device. A processor 230 operatively connected to the monitoring module 210 and the communication module 220 identifies the location and/or device type of the requesting mobile device. In at least one embodiment, the processor 230 identifies the time that the search query was received from the requesting mobile device.

In addition, the processor 230 identifies the assets used in the location of the requesting mobile device based on the usage of assets observed by the monitoring module 210. In at least one embodiment, utilizing the information obtained by the monitoring module 210, the processor 230 identifies assets utilized by the device type of the requesting mobile device and/or assets utilized during the time period that the search query was received from the requesting mobile device.

The system also includes a ranking module 232 within the processor 230. In another embodiment, the ranking module 232 is positioned outside of the processor 230. The ranking module 232 weighs results of the search query by assigning higher rankings to the assets used in the location of the requesting mobile device, assets used by the device type of the requesting mobile device, and/or assets utilized during the time period that the search query was received from the requesting mobile device.

The communication module 220 sends the results of the search query to the requesting mobile device and/or an interface. In at least one embodiment, the communication module 220 only sends assets that match the location of the requesting mobile device and/or assets that are compatible with the device type of the requesting mobile device.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute with the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

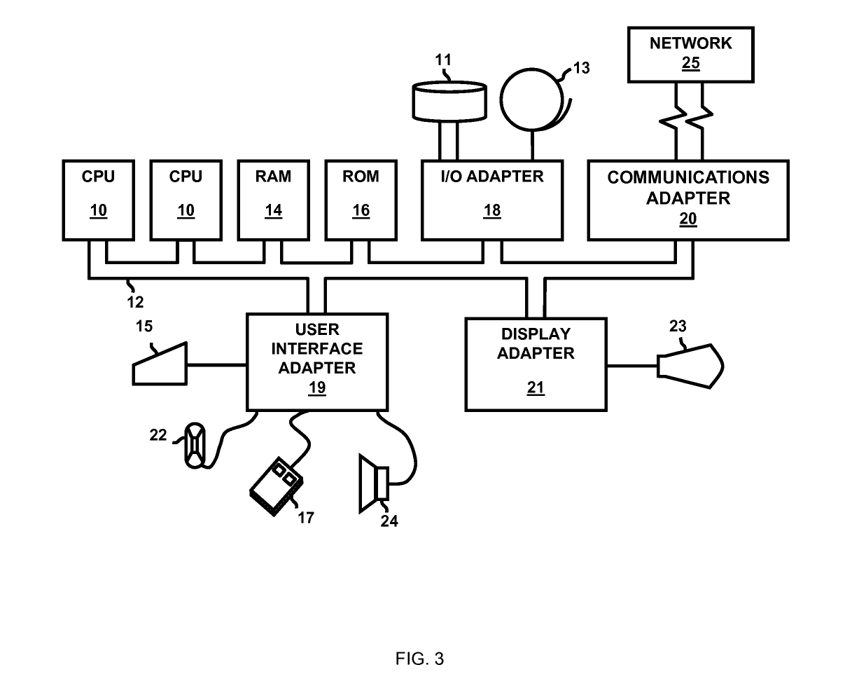

Referring now to FIG. 3, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for searching for assets based on location, said method including:
monitoring usage of assets in a plurality of mobile devices with a monitoring module, said monitoring including identifying assets used in different locations;
receiving a search query for a requested asset of the assets from a requesting mobile device;
identifying a location of the requesting mobile device;
identifying assets used in the location of the requesting mobile device based on said monitoring of the usage of assets in the plurality of mobile devices;
weighing results of the search query by assigning higher rankings to the assets used in the location of the requesting mobile device; and
sending the results of the search query to the requesting mobile device.

2. The method according to claim 1, wherein said identifying of the assets used in different locations includes, for each usage of an asset of the assets, identifying a location of a mobile device utilizing the asset.

3. The method according to claim 2, wherein said identifying of the location of the mobile device utilizing the asset and said identifying of the location of the requesting mobile device include receiving data from a global positioning system.

4. The method according to claim 1, wherein the usage of the assets includes at least one of downloading of the assets and launching of the assets.

5. The method according to claim 1, further including sending the results of the search query to an interface.

6. The method according to claim 1, wherein said monitoring of the usage of assets in the plurality of mobile devices further includes identifying assets used at different time periods,
wherein said method further includes identifying a time period that the search query was received from the requesting mobile device and identifying assets used during the time period that the search query was received from the requesting mobile device based on said monitoring of the usage of assets in the plurality of mobile devices, and
wherein said weighing of the results of the search query further includes assigning higher rankings to the assets used during the time period that the search query was received from the requesting mobile device.

7. The method according to claim 1, wherein said monitoring of the usage of assets in the plurality of mobile devices further includes identifying assets used by different device types,
wherein said method further includes identifying a device type of the requesting mobile device and identifying assets used with the device type of the requesting mobile device based on said monitoring of the usage of assets in the plurality of mobile devices, and
wherein said weighing of the results of the search query further includes assigning higher rankings to the assets used with the device type of the requesting mobile device.

8. The method according to claim 7, wherein said sending of the results of the search query includes only sending at least one of assets that match the location of the requesting mobile device and assets that are compatible with the device type of the requesting mobile device.

9. A method for searching for assets based on location and device type, said method including:
monitoring usage of assets in a plurality of mobile devices with a monitoring module, said monitoring including identifying assets commonly used in different locations and identifying assets commonly used by different device types;
receiving a search query for a requested asset of the assets from a requesting mobile device;
identifying a location of the requesting mobile device;
identifying assets commonly used in the location of the requesting mobile device based on said monitoring of the usage of assets in the plurality of mobile devices;
identifying a device type of the requesting mobile device;
identifying assets commonly used with the device type of the requesting mobile device based on said monitoring of the usage of assets in the plurality of mobile devices;
weighing results of the search query by assigning higher rankings to the assets commonly used in the location of the requesting mobile device and assigning higher rankings to the assets commonly used with the device type of the requesting mobile device; and
sending the results of the search query to the requesting mobile device.

10. The method according to claim 9, wherein said identifying of the assets commonly used in different locations includes, for each usage of an asset of the assets, identifying a location of a mobile device utilizing the asset.

11. The method according to claim 10, wherein said identifying of the location of the mobile device utilizing the asset and said identifying of the location of the requesting mobile device include receiving data from a global positioning system.

12. The method according to claim 9, wherein the usage of the assets includes at least one of downloading of the assets and launching of the assets.

13. The method according to claim 9, further including sending the results of the search query to an interface.

14. The method according to claim 9, wherein said monitoring of the usage of assets in the plurality of mobile devices further includes identifying assets commonly used at different time periods,
wherein said method further includes identifying a time period that the search query was received from the requesting mobile device and identifying assets commonly used during the time period that the search query was received from the requesting mobile device based on said monitoring of the usage of assets in the plurality of mobile devices, and
wherein said weighing of the results of the search query further includes assigning higher rankings to the assets commonly used during the time period that the search query was received from the requesting mobile device.

15. The method according to claim 9, wherein said sending of the results of the search query includes only sending at least one of assets that match the location of the requesting mobile device and assets that are compatible with the device type of the requesting mobile device.

16. A system for searching for assets based on location, said system including:
a monitoring module for monitoring usage of assets in a plurality of mobile devices to identify assets used in different locations;
a communication module for receiving a search query for a requested asset of the assets from a requesting mobile device;
a processor operatively connected to said monitoring module and said communication module, said processor identifies a location of the requesting mobile device and identifies assets used in the location of the requesting mobile device based on the monitoring of the usage of assets in the plurality of mobile devices; and
a ranking module in said processor, said ranking module weighs results of the search query by assigning higher rankings to the assets used in the location of the requesting mobile device,
said communication module sends the results of the search query to the requesting mobile device.

17. The system according to claim 16, wherein for each usage of an asset of the assets, said monitoring module identifies a location of a mobile device utilizing the asset.

18. The system according to claim 16, wherein said monitoring module and said processor include a global positioning system.

19. The system according to claim 16, wherein the usage of the assets includes at least one of downloading of the assets and launching of the assets.

20. The system according to claim 16, wherein said monitoring module further identifies assets used at different time periods,
wherein said processor further identifies a time period that the search query was received from the requesting mobile device and identifies assets used during the time period that the search query was received from the requesting mobile device based on the monitoring of the usage of assets in the plurality of mobile devices, and
wherein said ranking module further weighs the results of the search query by assigning higher rankings to the assets used during the time period that the search query was received from the requesting mobile device.

21. (canceled)

21. The system according to claim 16, wherein said monitoring module further identifies assets used by different device types,
wherein said processor further identifies a device type of the requesting mobile device and identifies assets used with the device type of the requesting mobile device based on the monitoring of the usage of assets in the plurality of mobile devices, and
wherein said ranking module further weighs the results of the search query by assigning higher rankings to the assets used with the device type of the requesting mobile device.

22. The system according to claim 21, wherein said communication module only sends at least one of assets that match the location of the requesting mobile device and assets that are compatible with the device type of the requesting mobile device.

23. A system for searching for assets based on location, said system including:
means for monitoring usage of assets in a plurality of mobile devices to identify assets used in different locations;
means for receiving a search query for a requested asset of the assets from a requesting mobile device;
means for identifying a location of the requesting mobile device and identifies assets used in the location of the requesting mobile device based on the monitoring of the usage of assets in the plurality of mobile devices;
means for weighing results of the search query by assigning higher rankings to the assets used in the location of the requesting mobile device; and
means for sending the results of the search query to the requesting mobile device.

24. A computer program product, for searching for assets based on location and device type, said computer program product including:
a computer readable storage medium;
first program instructions to monitor usage of assets in a plurality of mobile devices by identifying assets commonly used in different locations and identifying assets commonly used by different device types;
second program instructions to receive a search query for a requested asset of the assets from a requesting mobile device;
third program instructions to identify a location of the requesting mobile device;
fourth program instructions to identify assets commonly used in the location of the requesting mobile device based on the usage of assets monitored by the first program instructions;
fifth program instructions to identify a device type of the requesting mobile device;
sixth program instructions to identify assets commonly used with the device type of the requesting mobile device based on the usage of assets monitored by the first program instructions;
seventh program instructions to weigh results of the search query by assigning higher rankings to the assets commonly used in the location of the requesting mobile device and assigning higher rankings to the assets commonly used with the device type of the requesting mobile device; and
eighth program instructions to send the results of the search query to the requesting mobile device,
wherein said first program instructions, said second program instructions, said third program instructions, said fourth program instructions, said fifth program instructions, said sixth program instructions, said seventh program instructions, and said eighth program instructions are stored on said computer readable storage medium.

25. The computer program product according to claim 24, wherein said first program instructions further identifies assets commonly used at different time periods,
wherein said computer program product further includes ninth program instructions stored on said computer readable medium to identify a time period that the search query was received from the requesting mobile device and identify assets commonly used during the time period that the search query was received from the requesting mobile device based on the usage of assets monitored by the first program instructions, and
wherein said seventh program instructions further assigns higher rankings to the assets commonly used during the time period that the search query was received from the requesting mobile device.
